(19) United States
(12) Patent Application Publication
(10) Pub. No.: US 2006/0126683 A1
(43) Pub. Date: Jun. 15, 2006

(54) Optical transmitter having analog/digital mixed-mode temperature compensation function

(76) Inventors: Ho Yong Kang, Daejeon (KR); Sang Hoon Chai, Choongchungnam-do (KR); Hyun Kyun Choi, Daejeon (KR); Tae Whan Yoo, Daejeon (KR); Yool Kwon, Daejeon (KR); Bong Tae Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/139,106

(22) Filed: May 27, 2005

(30) Foreign Application Priority Data
Dec. 10, 2004 (KR) 10-2004-104349

(51) Int. Cl. H01S 3/00

(52) U.S. Cl. 372/38.02

(57) ABSTRACT

Disclosed herein is an optical transmitter having an analog/digital mixed-mode temperature compensation function. The optical transmitter, when detecting the optical output power of a laser diode, which outputs logic levels “1” and “0” as optical signals, through a monitoring photodiode, and controlling the bias current of a laser drive circuit to maintain the logic levels “1” and “0” at constant values, includes programs for controlling the bias current and modulation current of the laser drive circuit based on an variation in temperature, and is configured such that a temperature compensation circuit includes a digital control unit for controlling the bias current and modulation current of the laser drive circuit using the programs, so that temperature compensation operation can be adjusted only by the modification of the programs of the distal control unit.

### RELATED APPLICATION

The present application is based on, and claims priority from, Korean Application Number 2004-104349, field Dec. 10, 2004, the disclosure of which is incorporated by reference herein in its entirety.

### BACKGROUND OF THE INVENTION

1. Field of the Invention

The present invention relates generally to an optical transmitter having an analog/digital mixed-mode temperature compensation function, which provides an optical output having an extinction ratio above a specific level by performing appropriate temperature compensation regardless of the type and characteristics of a semiconductor laser diode, and which can be used not only as an optical transmitter that operates in a continuous wave mode in which the levels of the input signals are constant and periodic, but also as an optical transmitter that requires burst-mode operation in which the packet sizes of input signals are various.

2. Description of the Related Art

Generally, in a semiconductor laser diode used as an optical transmission device, the threshold current Ith of the semiconductor laser diode increases with an increase in the surrounding temperature of the semiconductor laser diode, so that the slope of a current-optical output characteristic curve is reduced. Accordingly, an Extinction Ratio (ER=P1/P0 where P1 is optical output corresponding to a logic level “1” and P0 is optical output corresponding to a logic level “0”), which is defined as the ratio of optical power corresponding to a logic level “1” and optical power corresponding to a logic level “0” from a digital point of view, decreases with an increase in temperature, so that the transmission efficiency of the semiconductor laser diode is lowered.

However, in the case of a transmission module for optical communication that is used for an optical network, the international telecommunication standard requires that the ER be above 8 dB to 10 dB, but the standard cannot be met in a specific temperature range due to the temperature characteristics of the above-described semiconductor laser diode. In particular, to facilitate reception in an optical receiver, the output powers P1 and P0 of a laser diode, which correspond to logic levels “1” and “0”, respectively, must be constant.

In a conventional optical transmitter shown in FIG. 7, a laser drive circuit 2 controls the driving current of a Laser Diode (LD) 1 according to input data so that an optical signal having a level corresponding to a digital signal is output. In this case, the optical output power of the LD 1 is detected by a monitoring PhotoDiode (PD) 3, the output of the monitoring PD 3 is amplified by an operational amplifier A3, and peak values corresponding to logic levels “1” and “0” are detected from the signal using peak value detectors A4 and A5. A comparator A8 compares the difference between +/−peak values detected by the detector A4 and A5 with a reference value corresponding to a logic level “1”, and the modulation current of the laser drive circuit 2 is controlled based on the comparison result.

After an average optical output value is set, an optical output value detected by the monitoring PD 3 is compared with an average optical output value using a comparator A9, and the bias current of the LD 1 is controlled based on the comparison result.

However, in the scheme of controlling the bias current of the LD based on the average optical output value, it is difficult to expect a desired temperature compensation effect because the variation in characteristics due to the temperature of the LD is not taken into account and, therefore, the ER rapidly varies when the slope of the characteristic curve of the LD varies with the temperature.

In more detail, as described above, the characteristics of the semiconductor LD vary with the variation in surrounding temperature, so that the slope of the characteristic curve gradually decreases with an increase in temperature and, therefore, an average optical output decreases when the amplitude of the demodulation current is constant. Accordingly, to provide an ER above a specific level regardless of variation in temperature, the modulation current of the LD must be increased according to variation in temperature. Furthermore, if the bias current of the LD does not increase with an increase in temperature, the output of the LD corresponding to the logic level “0” does not reach the threshold current of the LD, so that serious signal distortion may occur on a receiving side.

To overcome the above-described problem, a scheme of providing a uniform optical output while maintaining the ER identical to that at a low temperature in spite of an increase in temperature through the control of the modulation current and the bias current using top and bottom hold circuits.

FIG. 8 is a circuit diagram showing a conventional optical transmitter according to such an improved scheme. The improved conventional transmitter includes top and bottom hold circuits 821 and 831, and a bias current control unit 82 and a modulation current control unit 83 that compensate for the characteristic in which the optical output power of the LD 1 decreases with an increase in surrounding temperature with respect to the same driving current.

In the optical transmitter, the output current of monitoring PD 3 is input to a Trans-Impedance-Amplifier (TIA) 81, converted into a voltage signal, and then applied to both the top hold circuit 821 of the bias current control unit 82 and the bottom hold circuit 831 of the modulation current control unit 83. The top and bottom hold circuits 821 and 831 follow the maximum and the minimum values of the voltage input from TIA 81 and feed back DC voltage values, which correspond to the maximum and minimum values, to the laser drive circuit 2, so that the driving current of the laser drive circuit 2 is controlled such that the semiconductor LD 1 outputs constant optical powers corresponding to logic levels “0” and “1”.

That is, the detection output of the LD 1, which corresponds to the point P0 of FIG. 2, has the maximum voltage level. Accordingly, the top hold circuit 821 provides a DC voltage value, which corresponds to the maximum voltage, as a side input of an operational amplifier 822. In this case, when the level of the detection output drops as operating temperature increases, the output voltage of the top hold circuit 821 exhibits a DC voltage value higher than that of a reference voltage REF1 and the operational amplifier 822 increases the bias current of the LD 1 by the deviation, thus increasing the maximum level of the optical output. Accordingly, when a reference voltage is set regardless of the type of the LD, the maximum level of the laser LD 1 does not drop below the set level through the above-described feedback control. Similarly, the bottom hold circuit 831 follows the maximum level of the optical output of the laser LD 1, which is input from the TIA 81, and applies a DC voltage value, which corresponds to the corresponding minimum level (the P1 level of FIG. 2), to the minus input terminal of the operational amplifier 832. When the detected minimum level differs from a reference voltage REF2, the operational amplifier 832 adjusts the modulation current of the laser drive circuit based on the deviation, thus allowing the optical output, having the same voltage level as the reference voltage REF2, to be output through the laser LD 1.

Since the above-proposed optical transmitter is directly controlled through an analog feedback circuit including the TIA 81, the top and bottom hold circuits 821 and 831, and the operational amplifiers 822 and 832, reliable control can be achieved when the optical transmitter is correctly designed. However, if there is a problem with a parameter used in the design of the optical transmitter or with a chip manufacturing process, the optical transmitter is problematic in that an error in a finished optical transmitter cannot be corrected. In particular, in the case in which the optical transmitter operates in a burst mode, the feedback operation of the analog feedback circuit including the TIA 81, the top and bottom hold circuits 821 and 831, and the operational amplifiers 822 and 832 must be completed within a single burst interval because the real-time control of the optical transmitter must be performed whenever a burst signal is input. However, the analog feedback circuit described above is problematic in that the operation speed of the feedback circuit itself cannot meet the requirement.

Furthermore, since the conventional optical transmitter generates a bias current control signal or a modulation current control signal in a burst enable region, it is very difficult to design the optical transmitter to allow temperature compensation operation to be performed only in a structurally necessary region (data on region). Further, unnecessary voltage is generated by the top and bottom hold circuits 821 and 831 at time points, such as the moment just after reset is released, so that an error in control operation of the bias current and the modulation current may occur.

Furthermore, since the conventional optical transmitter turns off a current source in a burst disable region and then turns on the current source in the remaining regions in which a bias current or modulation current control signal is generated, noise due to the turning-on and off of the current source may occur.

### SUMMARY OF THE INVENTION

Accordingly, the present invention has been made keeping in mind the above problems occurring in the prior art, and an object of the present invention is to provide an optical transmitter having an analog/digital mixed-mode temperature compensation function, which can perform appropriate temperature compensation regardless of the type and the characteristics of a semiconductor laser diode, and which can reliably operate without noise not only in a continuous wave mode in which the levels of the input signals are constant and periodic, but also in a burst mode in which the packet sizes of input signals are various.

In order to accomplish the above object, the present invention provides an optical transmitter having an analog/digital mixed-mode temperature compensation function, including a laser diode for generating an optical signal; a laser drive circuit for controlling an optical output level of the laser diode according to input data; a monitoring PD adapted to operate according to the optical signal output from the laser diode and to output a current corresponding to the optical signal; a TIA for converting the current, which is output from the monitoring PD, into a voltage signal; an analog control unit for detecting both maximum and minimum levels of the output voltage of the TIA and calculating deviation values of the detected maximum and minimum levels from predetermined reference values, respectively; and a digital control unit including programs for controlling bias and modulation currents of the laser drive circuit based on variation in temperature, and controlling the bias and modulation currents of the laser drive circuits using the programs while using the maximum and minimum levels calculated from the analog control unit as the reference values.

In the optical transmitter according to the present invention, the analog control unit includes a top hold circuit for detecting the maximum level of output voltage of the TIA and outputting a DC voltage value corresponding to a detected maximum level; a bottom hold circuit for detecting the minimum level of the output voltage of the TIA and outputting a DC voltage value corresponding to a detected maximum level; a first operational amplifier for obtaining a deviation value of an output value of the top hold circuit from a first reference value corresponding to a digital signal “1”; and a second operational amplifier for obtaining a deviation value of an output value of the bottom hold circuit from a second reference value corresponding to a digital signal “0.”

Furthermore, in the optical transmitter according to the present invention, the TIA is a common mode TIA that is connected to a cathode of the monitoring PD and converts the output current of the monitoring PD into a voltage without phase inversion.

Furthermore, in the optical transmitter according to the present invention, the digital control unit includes a bias current digital control unit for, using the deviation value of the first operational amplifier as the first reference value, reducing the bias current of the laser drive circuit so that the output level of the laser drive circuit increases if the maximum optical output level of the laser diode is less than the first reference value, and increasing the bias current of the laser drive circuit so that the output level of the laser drive circuit decreases if the maximum optical output level of the laser diode is equal to or greater than the first reference value; and a modulation current digital control unit for, using the deviation value of the second operational amplifier as the second reference value, reducing the modulation current of the laser drive circuit so that the output level of the laser drive circuit increases if the minimum optical output level of the laser diode is less than the second reference value, and increasing the modulation current of the laser drive circuit so that the output level of the laser drive circuit decreases if the minimum optical output level of the laser diode is equal to or greater than the first reference value.

Furthermore, in the optical transmitter according to the present invention, the bias current digital control unit and the modulation current digital control unit each includes an analog-to-digital converter for converting an input analog deviation signal into a digital signal; a digital processor having a program for setting a relationship between the deviation value of the first or second operational amplifier and a bias or modulation current so as to analyze the deviation value input from the analog-to-digital converter using the program and output a bias current or modulation current control signal; and a digital output unit for outputting the control signals, which are output from the digital processor, as a digital signal for turning on and off m current sources provided in the laser drive circuit.

Furthermore, in the optical transmitter according to the present invention, the bias current digital control unit and the modulation current digital control unit each includes an analog-to-digital converter for converting an input analog deviation signal into a digital signal; a digital processor having a program for setting a relationship between the deviation values of the first and second operational amplifier and a bias or modulation current so as to analyze the deviation value, which is input from the analog-to-digital converter, using the program and output a bias current or modulation current control signal; and a digital-to-analog converter for converting the control signal, which is output from the digital processor, into an analog signal for linearly controlling a current source of the laser drive circuit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a circuit diagram showing an optical transmitter according to the present invention;

FIG. 2 is a graph showing the characteristic variation curve of an LD;

FIG. 3 is a detailed block diagram showing the bias current digital control unit of an optical transmitter according to an embodiment of the present invention;

FIG. 4 is a detailed block diagram showing the modulation current digital control unit of an optical transmitter according to an embodiment of the present invention;

FIG. 5 is a block diagram showing the bias current digital control unit of an optical transmitter according to another embodiment of the present invention;

FIG. 6 is a block diagram showing the modulation current digital control unit of an optical transmitter according to another embodiment of the present invention;

FIG. 7 is a circuit diagram showing a conventional optical transmitter; and

FIG. 8 is a circuit diagram showing an improved conventional optical transmitter.

### DESCRIPTION OF THE PREFERRED EMBODIMENTS

Preferred embodiments of the present invention are described in detail with reference to the accompanying drawings below.

The present invention is characterized in that a feedback circuit for compensating for the optical output characteristic of an LD depending on the variation in temperature is implemented by combining an analog circuit and a digital circuit, so that temperature compensation operation can be controlled from the outside regardless of the type and the characteristics of an LD, and an ER above a specific level and constant optical output are always provided.

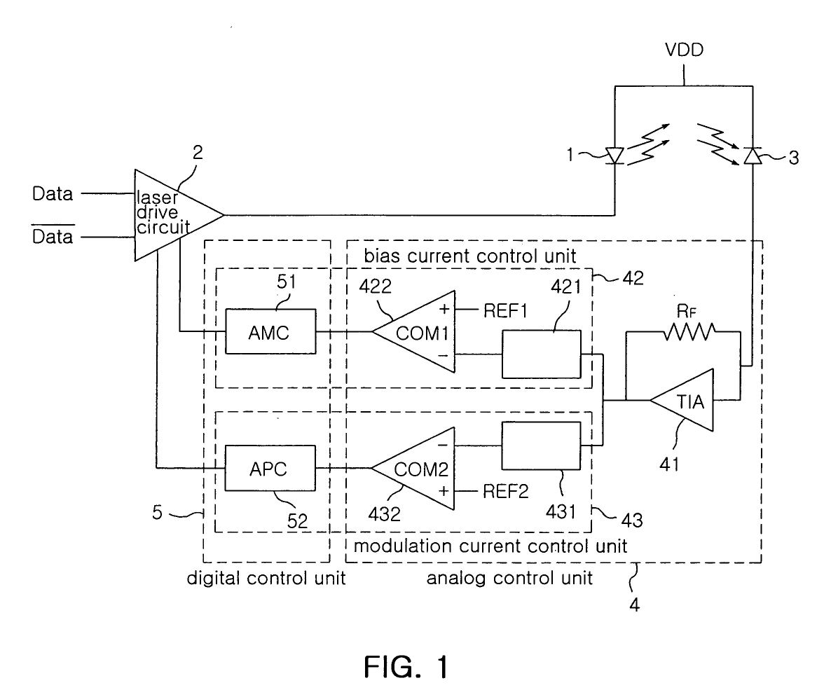

FIG. 1 is a circuit diagram showing the entire construction of an optical transmitter according to the present invention.

Referring to FIG. 1, reference numeral ‘1’ designates an LD for providing an optical output in response to an input signal, reference numeral ‘2’ indicates a laser drive circuit for controlling the optical output of the LD 1 according to input data, and ‘3’ designates a monitoring PD for detecting the power of an optical output generated from the LD 1.

Furthermore, to compensate for the characteristic in which the optical output power of the LD 1 decreases for the same driving current with an increase in surrounding temperature with respect to the same driving current, the optical transmitter of the present invention includes an analog control unit 4 for performing a comparison operation on the detection result of the monitoring PD 3, and a digital control unit 5 for controlling the bias current and modulation current of the laser drive circuit 2 according to the output of the analog control unit 4.

The analog control unit 4 includes a TIA 41 for converting the output current of the monitoring PD 3 into a voltage signal, top and bottom hold circuits 421 and 431 for following the top and bottom levels of the output signal of the TIA 41 and outputting DC voltage values corresponding to top and bottom levels, and first and second operational amplifiers 422 and 432 for comparing the top and bottom levels of optical outputs, which are output from the top and bottom hold circuits 421 and 431, with upper and lower limit reference values REF1 an REF2, respectively, and outputting signals corresponding to the deviation values. The digital control unit 5 includes a bias current digital control unit 51 that is driven by a predetermined program, analyzes the deviation value output from the first operational amplifier 422 and controls the bias current of the laser drive circuit 2, and a modulation current digital control unit 52 that is driven by a predetermined program, analyzes the deviation value output from the second operational amplifier 432 and controls the modulation current of the laser drive circuit 2.

The gain of the TIA 41 is determined by the resistance value of a resistor R_{F}. Although a general amplifier is designed in an inverter form in which the phase of an input signal is inverted by 180 degrees, in the present invention, the TIA 41 is implemented using a common mode TIA in which phase inversion does not occur.

The top and bottom hold circuits 421 and 431 output DC voltages corresponding to the maximum voltage and minimum values of the output voltage of the TIA 41.

The maximum and minimum levels of the optical outputs, which are output from the top and bottom hold circuit 421 and 431, are compared with the reference values REF1 and REF2, respectively, and the bias and modulation current digital control units 51 and 52 control the laser drive circuit 2 based on the comparison result so that the output powers corresponding to the logic levels “0” and “1” of the optical signal generated by the LD 1 can be maintained at the reference values REF1 and REF2, respectively.

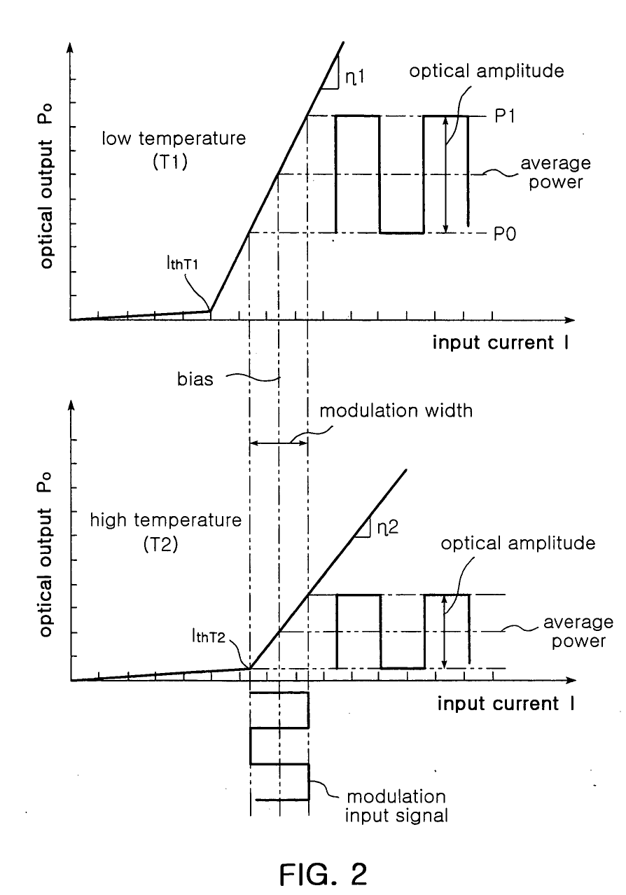

The above-described operation is described in more detail with reference to the graph of FIG. 2 below. The output current of the monitoring PD 3 that corresponds to the output of the LD 1 at P1 is detected as the maximum voltage level through the TIA 41 and the top hold circuit 421, converted into a DC voltage value corresponding to a corresponding level, and provided to a side input terminal of the first operational amplifier 422. The reference voltage REF1 corresponding to the threshold value of a logic level “1” is applied to another input terminal of the first operational amplifier 422, and the first operational amplifier 422 outputs the deviation value of the detected maximum level from the reference voltage REF1. In the case in which the maximum level P1 drops due to an increase in temperature, the deviation value output from the first operational amplifier 422 increases. At this time, the bias current digital control unit 51 detects the increased deviation value and controls the bias current of the drive circuit 2 to increase the output level of the LD 1. In contrast, when the maximum level P1 increases due to a decrease in temperature, the deviation value output from the first operational amplifier 422 decreases. At this time, the bias current digital control unit 51 detects the decreased deviation value and controls the bias current of the drive circuit 2 to decrease the output level of the LD 1.

Likewise, the output current of the monitoring PD 3 that corresponds to the optical output of the LD 1 at P0 is converted into voltage through the TIA 41, and detected as the minimum voltage level by the bottom hold circuit 431, and transferred to the second operational amplifier 432. Since the reference voltage REF2 corresponding to the optical output threshold value of a logic level “0” is applied to another side input terminal of the second operational amplifier 432, the second operational amplifier 432 amplifies the difference between the minimum level of the optical power detection value and the reference voltage REF2. In this case, when the minimum level P0 of the optical output drops below the reference voltage REF2 due to an increase in the surrounding temperature of the LD 1, the output voltage of the second operational amplifier 432 increases. At this time, the modulation current digital control unit 52 detects the increased output voltage and raises the P0 level by increasing the modulation current of the drive circuit 2. In contrast, since a higher DC value is output from the bottom hold circuit 431 when the minimum level P0 of the optical output increases due to a decrease in temperature, the output voltage of the second operational amplifier 432 decreases. At this time, the modulation current digital control unit 52 detects the decreased output voltage and lowers the P0 level by controlling the drive circuit 2.

The bias and modulation current digital control units 51 and 52 set reference control voltages to the outputs of the first and second operational amplifiers 422 and 432, respectively, and controls the laser drive circuit 2 using contained programs.

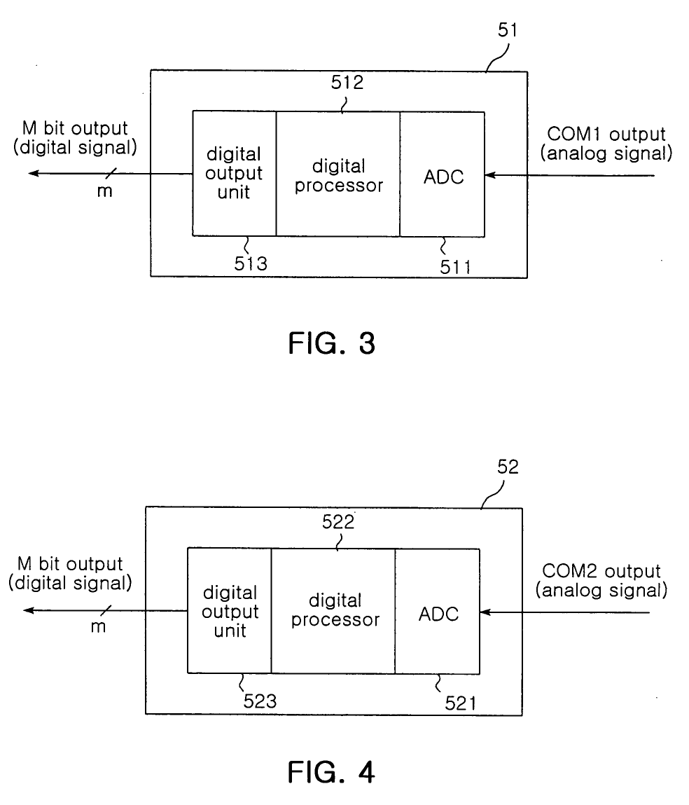

FIGS. 3 and 4 are block diagrams showing first embodiments of bias and modulation current digital control units, respectively.

Referring to FIGS. 3 and 4, the bias and modulation current digital control units 51 and 52 each include an analog-to-digital converter 511 or 521, a digital processor 512 or 522, and a digital output unit 513 or 523.

That is, when an analog signal output COM1 or COM2 of the first or second operational amplifiers 422 or 432 is converted into a digital signal and the digital signal is applied to the digital processor 512 or 522, the digital signal is sampled at a specific time point at which the signal is stabilized, is analyzed using a contained program, and undergoes predetermined processing, is converted into an m bit digital signal for controlling the laser drive circuit 2 in the digital output unit 513 or 523, and is then output. The m bit digital signal that is output from the digital output unit 513 or 523 selectively turns on and off m current sources that are included in the laser drive circuit 2 and that have the same size, a reference size, or multiples of the reference size, so that the bias and modulation currents supplied to the LD 1 are controlled.

In the above-described process, the control of the current sources of the laser drive circuit 2 based on the deviation values output from the first and second operational amplifier 422 and 432 are dependent on the programs of the digital processors 512 and 522. Accordingly, the degree of temperature compensation can be adjusted by changing the programs of the digital processor 512 and 522 according to necessity.

Furthermore, the bias and modulation current digital control units 51 and 52 of the optical transmitter according to the present invention may linearly control a single bias current source of the drive circuit 2.

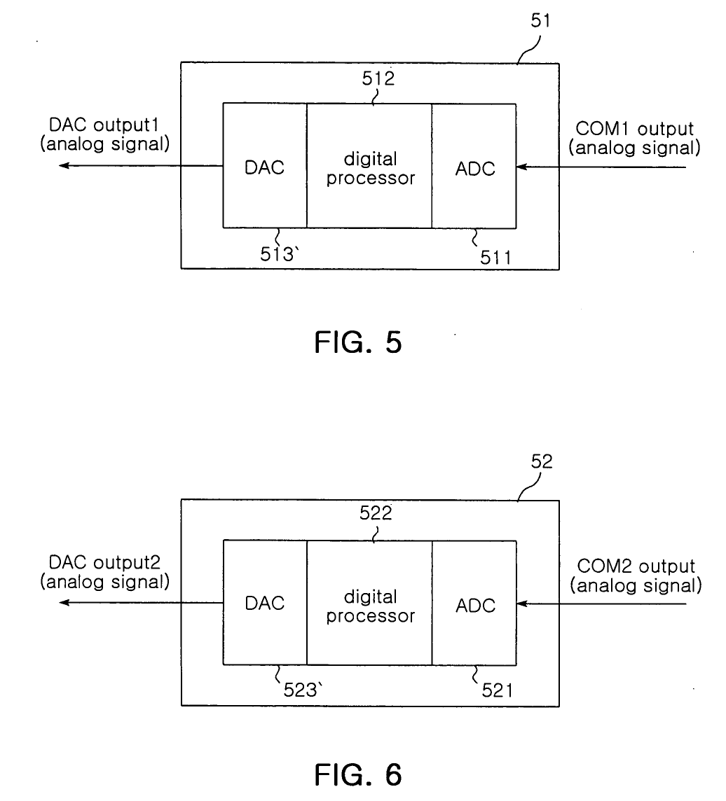

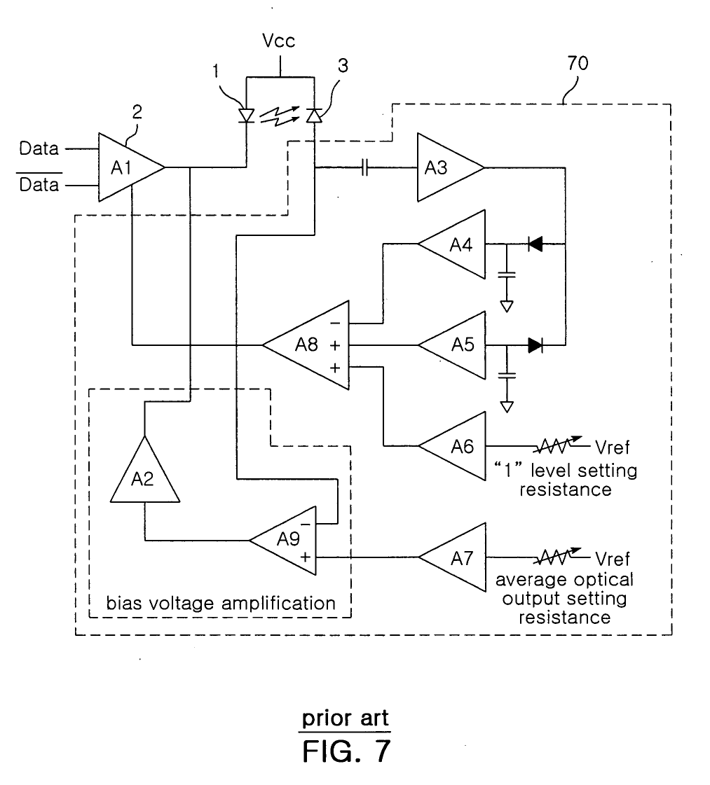

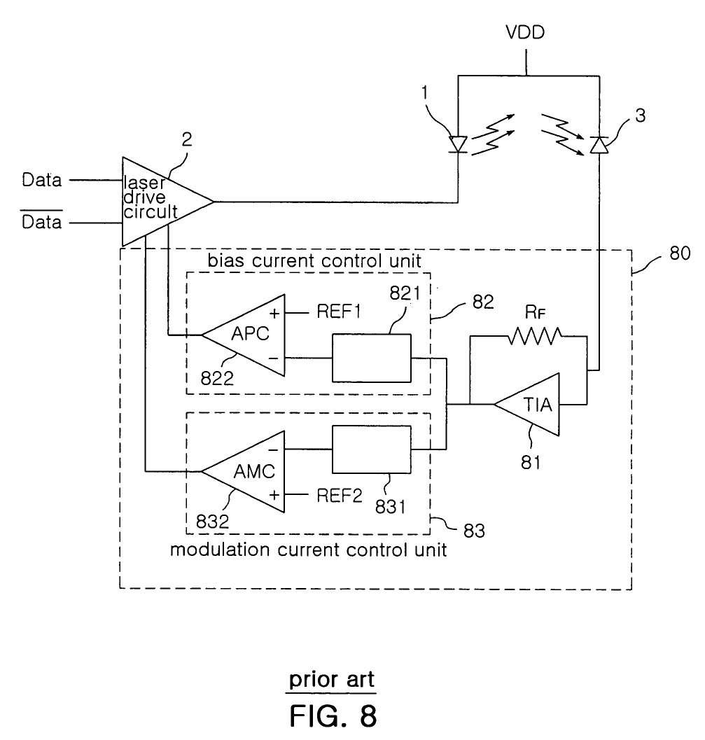

FIGS. 5 and 6 are block diagrams showing second embodiments of the bias and modulation current digital control units 51 and 52, respectively, which are applied to the case in which the bias current source of the drive circuit 2 is linearly controlled.

Referring to FIGS. 5 and 6, the bias and modulation current digital control units 51 and 52 each include an analog-to-digital converter 511 or 521, a digital processor 512 or 522, and a digital-to-analog converter 513′ or 523′.

Each of the bias and modulation current digital control units 51 and 52 in accordance with second embodiments, like the first embodiments, sets a reference voltage to the output of the first or second operational amplifier 422 or 432, inputs it to the digital processor 512 or 522, and controls the laser drive circuit 2 using a set program. In this case, the analog signal output of the first or second operational amplifier 422 or 432 is converted into a digital signal through the analog-to-digital converter 511 or 521, and the digital signal is input to the digital processor 512 or 522. The digital processor 512 or 522 samples the digital signal at a specific time point at which the input digital signal is stabilized, analyzes corresponding sampling value, and performs predetermined processing, and produces an n bit digital signal for controlling the laser drive circuit 2. Digital control signals are converted into analog signals in the digital-to-analog converters 513′ and 523′, and are applied to the laser drive circuit 2, so that the current source of the laser drive circuit 2 is linearly controlled.

As described above, in the second embodiments, by changing and correcting the programs of the digital processors 512 and 522, the degree of temperature compensation can be controlled and an operation error can be corrected from the outside.

The digital processors 512 and 522 of the first and second embodiments may be constructed using commercialized chips, or may be implemented in such a way that they are embedded in one chip using a library, like analog circuits.

As described above, the optical transmitter of the present invention can perform a temperature compensation function to fit the temperature characteristics of the LD merely by appropriately changing and correcting programs from the outside. Accordingly, the optical transmitter of the present invention can be more flexibly applied to a burst mode optical transmission module for optical communication as well as an existing continuous signal mode optical transmission module for optical communication.

Furthermore, although there occurs a problem with a parameter used in the design of a temperature compensation circuit or with a chip manufacturing process, an error can be corrected by controlling the bias and modulation currents using micro programming, or correcting only control programs from the outside. Furthermore, the optical transmitter of the present invention is advantageous in that it can perform flexible programming control in a wider range by performing control using digital sampling rather than real time control using an existing analog circuit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical transmitter having an analog/digital mixed-mode temperature compensation function, comprising:
a laser diode for generating an optical signal;
a laser drive circuit for controlling an optical output level of the laser diode according to input data;
a monitoring PhotoDiode (PD) being adapted to operate according to the optical signal output from the laser diode and to output a current corresponding to the optical signal;
a Trans-Impedance Amplifier (TIA) for converting the current, which is output from the monitoring PD, into a voltage signal;
an analog control unit for detecting both maximum and minimum levels of the output voltage of the TIA and calculating deviation values of the detected maximum and minimum levels from predetermined reference values, respectively; and
a digital control unit including programs for controlling bias and modulation currents of the laser drive circuit based on variation in temperature, and controlling the bias and modulation currents of the laser drive circuits using the programs while using the maximum and minimum levels calculated from the analog control unit as the reference values.

2. The optical transmitter as set forth in claim 1, wherein the analog control unit comprises:
a top hold circuit for detecting the maximum level of output voltage of the TIA and outputting a DC voltage value corresponding to a detected maximum level;
a bottom hold circuit for detecting the minimum level of the output voltage of the TIA and outputting a DC voltage value corresponding to a detected maximum level;
a first operational amplifier for obtaining a deviation value of an output value of the top hold circuit from a first reference value corresponding to a digital signal “1”; and
a second operational amplifier for obtaining a deviation value of an output value of the bottom hold circuit from a second reference value corresponding to a digital signal “0.”

3. The optical transmitter as set forth in claim 1, wherein the TIA is a common mode TIA that is connected to a cathode of the monitoring PD and converts the output current of the monitoring PD into a voltage without phase inversion.

4. The optical transmitter as set forth in claim 2, wherein the digital control unit comprises:
a bias current digital control unit for, using the deviation value of the first operational amplifier as the first reference value, reducing the bias current of the laser drive circuit so that the output level of the laser drive circuit increases if the maximum optical output level of the laser diode is less than the first reference value, and increasing the bias current of the laser drive circuit so that the output level of the laser drive circuit decreases if the maximum optical output level of the laser diode is equal to or greater than the first reference value; and
a modulation current digital control unit for, using the deviation value of the second operational amplifier as the second reference value, reducing the modulation current of the laser drive circuit so that the output level of the laser drive circuit increases if the minimum optical output level of the laser diode is less than the second reference value, and increasing the modulation current of the laser drive circuit so that the output level of the laser drive circuit decreases if the minimum optical output level of the laser diode is equal to or greater than the first reference value.

5. The optical transmitter as set forth in claim 4, wherein the bias current digital control unit and the modulation current digital control unit each comprises:
an analog-to-digital converter for converting an input analog deviation signal into a digital signal;
a digital processor having a program for setting a relationship between the deviation value of the first or second operational amplifier and a bias or modulation current so as to analyze the deviation value input from the analog-to-digital converter using the program and output a bias current or modulation current control signal; and
a digital output unit for outputting the control signals, which are output from the digital processor, as a digital signal for turning on and off m current sources provided in the laser drive circuit.

6. The optical transmitter as set forth in claim 4, wherein the bias current digital control unit and the modulation current digital control unit each comprises:
an analog-to-digital converter for converting an input analog deviation signal into a digital signal;
a digital processor having a program for setting a relationship between the deviation values of the first and second operational amplifier and a bias or modulation current so as to analyze the deviation value, witch is input from the analog-to-digital converter, using the program and output a bias current or modulation current control signal; and
a digital-to-analog converter for converting the control signal, which is output from the digital processor, into an analog signal for linearly controlling a current source of the laser drive circuit.
